(19) United States
(12) Patent Application Publication
(10) Pub. No.: US 2022/0028255 A1
(43) Pub. Date: Jan. 27, 2022

(54) TRAFFIC INFORMATION ANALYSIS DEVICE AND TRAFFIC INFORMATION ANALYSIS METHOD

(71) Applicant: HONDA MOTOR CO., LTD., Tokyo (JP)

(72) Inventors: Minoru FUKUMORI, Tokyo (JP); Yoshiaki SUGIMOTO, Tokyo (JP)

(21) Appl. No.: 17/292,726

(22) PCT Filed: Sep. 13, 2019
(86) PCT No.: PCT/JP2019/036139

§ 371 Date: May 11, 2021

(51) Int. Cl. G08G 1/01; G06Q 30/02; G08G 1/00

(52) U.S. Cl. CPC G08G 1/0125; G09F 15/00; G08G 1/20; G06Q 30/0246

(57) ABSTRACT

Provided are a traffic information analysis device and a traffic information analysis method with which the effectiveness of a sign can be analyzed from the number of passages of moving bodies along a road where the sign is positioned. A traffic information analysis device 30 comprises: a visit information database update unit 311 that receives changes in location information for a plurality of vehicles 60; a storage unit 32 that stores a road on which the plurality of vehicles 60 can travel; a number of passages tallying unit 313 that tallies the number of passages of the plurality of vehicles 60 within a prescribed period for a prescribed location or a prescribed section of the road; and an output unit 314 that outputs a unit number and/or a ratio for each number of passages.

### TECHNICAL FIELD

The present invention relates to a traffic information analysis device and a traffic information analysis method for traffic information analysis regarding mobile bodies.

### BACKGROUND ART

Conventionally, when positioning a sign for a store such as a restaurant in a location visible from a road adjacent to the store in order to attract customers, the position of the sign is decided to be, for example, about 1 km away from the store. However, there is a problem with displaying information such as guidance etc. on a roadside sign to unspecified people (vehicles), in that it is not possible to clearly grasp the effectiveness thereof.

In this regard, Patent Document 1 proposes a method for distributing advertisement information in which location information of clients is received, the number of client traveling times is calculated and stored, and advertisement information corresponding to the number of client traveling times in the distribution area is transmitted.

In addition, Patent Document 2 proposes a route advertising frame setting apparatus, a route advertising frame setting method, and a route advertising frame setting program which can distribute associated advertisement information according to a route on a map including location information of a user terminal.

Patent Document 1: Japanese Unexamined Patent Application Publication No. 2002-157509

Patent Document 2: Japanese Unexamined Patent Application Publication No. 2009-169500

### DISCLOSURE OF THE INVENTION

### Problems to be Solved by the Invention

However, Patent Documents 1 and 2 relate to technology for distributing advertisements directly to a client (user) which cannot be applied to all mobile bodies traveling on a road like a sign can, and thus has limited effectiveness.

Moreover, with the technology of Patent Documents 1 and 2 it is still not possible to analyze the relation between the flow of mobile bodies and the effectiveness of the roadside sign.

It is an object of the present invention to provide a traffic information analysis device and traffic information analysis method with which the effectiveness of a sign can be analyzed from the number of passages of moving bodies along a road where the sign is positioned.

Means for Solving the Problems

(1) A traffic information analysis device (for example, a traffic information analysis device 30 described below) according to the present invention includes: a receiving unit (for example, a visit information database 311 described below) that receives changes in location information for a plurality of mobile bodies; a map information storage unit (for example, a storage unit 32 described below) that stores a road on which the plurality of mobile bodies can travel; the number-of-passages tallying unit (for example, the number-of-passages tallying unit 313 described below) that tallies the number of passages of the plurality of mobile bodies within a predetermined period for a predetermined location or predetermined section of the road; and an output unit (for example, an output unit 314 described later) that outputs the number and/or ratio of mobile bodies for each number of passages.

The above aspect (1) allows for an effectiveness analysis of respectively a sign aimed at chance customers and a sign aimed at locals, based on a passage frequency of the road where the sign is placed.

(2) In the traffic information analysis device described in the above aspect (1), the number-of-passages tallying unit may further tally the number of passages for the plurality of mobile bodies respectively for weekdays and for holidays,

The above aspect (2) allows for an effectiveness analysis and a consideration of placement location of a sign targeting commuter vehicles or business vehicles on weekdays, or a sign targeting leisure travelers on holidays.

(3) The traffic information analysis device described in the above aspects (1) or (2) may further include: a home location identifying unit configured to register in advance or identify by a tally of departure locations and/or arrival locations a home location for each of the plurality of mobile bodies, the number-of-passages tallying device further tallying the number of passages for mobile bodies having a home location that is beyond a predetermined distance from the predetermined section or predetermined location.

The above aspect (3) allows for exclusion of locals, enabling an effectiveness analysis and a consideration of placement location of a sign targeting leisure travelers from far away, etc.

(4) In the traffic information analysis device described in any of the above aspects (1) to (3), the map information storage unit may further store a location of a facility, and the number-of-passages tallying unit may further have as a tallying target a predetermined section of a road identified by a movement route of a vehicle that has passed the location of the facility that has been designated.

The above aspect (4) facilitates consideration of which location to place a sign in associated with a designated facility by having a traffic flow road of the designated facility as a processing target.

(5) A traffic analysis method according to the present invention is a traffic information analysis method performed by one or more computers having a map information storage unit storing a road on which a plurality of mobile bodies can travel, the method including: a receiving step of receiving changes in location information for the plurality of mobile bodies; the number-of-passages tallying step of tallying the number of passages of the plurality of mobile bodies within a predetermined period for a predetermined location or predetermined section of the road; and an output step of outputting the number and/or ratio of mobile bodies for each number of passages.

The method of the above aspect (5) exhibits the same effect as the traffic information analysis device of the above aspect (1).

### Effects of the Invention

According to the present invention, the effectiveness of a sign can be analyzed from the number of passages of moving bodies along a road where the sign is positioned.

### BRIEF DESCRIPTION OF THE DRAWINGS

FIG. 1 is a block diagram showing an overall basic configuration of a traffic information analysis system according to a first embodiment of the present invention;

FIG. 2 is a functional block diagram showing a functional configuration of an onboard navigation device according to the first embodiment of the present invention;

FIG. 3 is a functional block diagram showing a functional configuration of a portable terminal according to the first embodiment of the present invention;

FIG. 4 is a functional block diagram showing a functional configuration of a traffic information analysis device according to the first embodiment of the present invention;

FIG. 5 is a view showing an example of a visit information database according to the first embodiment of the present invention;

FIG. 6 is a view showing an example of a route information database according to the first embodiment of the present invention;

FIG. 7A is a view showing an example of outputting the number and/or ratio of mobile bodies for each number of passages according to the first embodiment of the present invention;

FIG. 7B is a view showing an example of outputting the number and/or ratio of mobile bodies for each number of passages according to the first embodiment of the present invention;

FIG. 8 is a flowchart showing a basic operation at a time of an update process of the visit information database according to the first embodiment of the present invention;

FIG. 9 is a flowchart showing a basic operation at a time of an analysis process according to the first embodiment of the present invention;

FIG. 10 is a functional block diagram showing a functional configuration of a traffic information analysis device according to a second embodiment of the present invention;

FIG. 11 is a flowchart showing a basic operation at a time of an analysis process according to the second embodiment of the present invention;

FIG. 12 is a view showing an example of a relation between a designated facility and a predetermined section according to a third embodiment of the present invention; and

FIG. 13 is a flowchart showing a basic operation at a time of an analysis process according to the third embodiment of the present invention.

### PREFERRED MODE FOR CARRYING OUT THE INVENTION

### <First Embodiment>

Hereinafter, a first embodiment of a traffic information analysis system according to the present invention will be described in detail with reference to the accompanying drawings.

### <Basic Configuration of Traffic Information Analysis System 1>

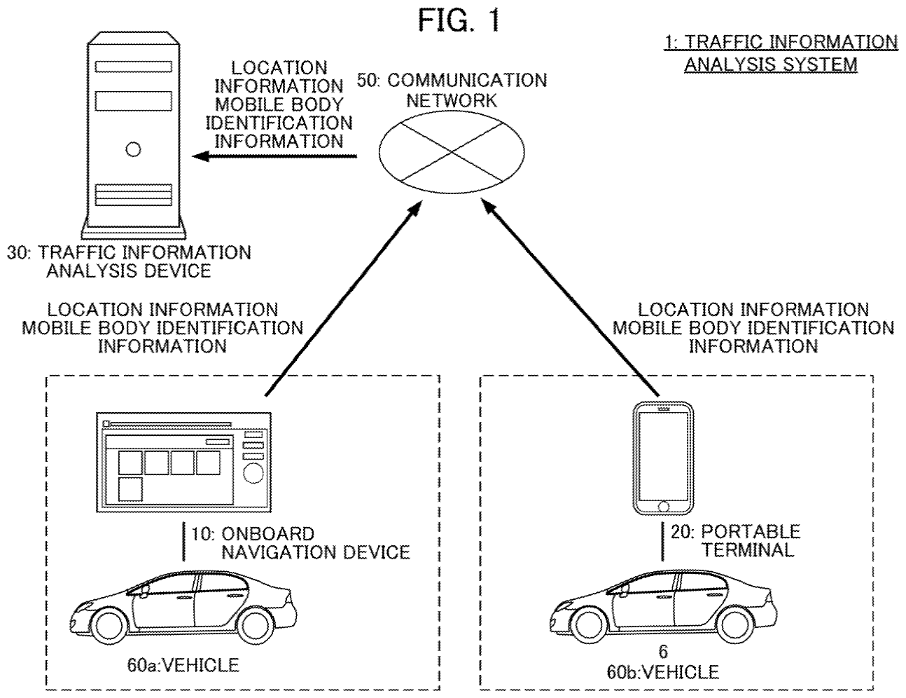

A traffic information analysis system 1 according to the first embodiment of the present invention will be described. FIG. 1 shows an overall configuration of the traffic information analysis system 1.

As shown in FIG. 1, the traffic information analysis system 1 includes an onboard navigation device 10, a portable terminal 20, and a traffic information analysis device 30. These devices and terminal are communicably connected to each other via a communication network 50. It should be noted that while information transmitted and received by these devices and terminals is illustrated in the drawing, this information is merely an example. In the first embodiment, information other than that illustrated may be transmitted and received.

The onboard navigation device 10 is a device that performs navigation (route guidance) with respect to a user in a vehicle 60a. The onboard navigation device 10 performs route guidance from a current position to a destination based on a request of the user. In addition, the onboard navigation device 10 also has a function of measuring location information of the onboard navigation device 10 (that is, location information of the vehicle 60a). The location information measured by the onboard navigation device 10 is appropriately transmitted to the traffic information analysis device 30 together with mobile body identification information for identifying the vehicle 60a.

The onboard navigation device 10 can be realized by a car navigation device that is provided in the vehicle 60a that is a mobile body, or a portable navigation device (PND) that is simply provided in a vehicle 60a that is a mobile body. In addition, the onboard navigation device 10 can be realized by an electronic device such as a smart phone on which a certain application is installed.

The portable terminal 20 is a portable terminal used by a user in a vehicle 60b. The portable terminal 20 has a function of measuring location information of the portable terminal 20 (that is, location information of the vehicle 60b), like the onboard navigation device 10. The location information measured by the portable terminal 20 is appropriately transmitted to the traffic information analysis device 30 like the location information measured by the onboard navigation device 10, together with mobile body identification information for identifying the vehicle 60b. The mobile body identification information may be acquired by the portable terminal 20 from the vehicle 60b, or identification information of the portable terminal 20 itself may be considered the mobile body identification information. The portable terminal 20 can be realized by a smart phone, a mobile phone, a tablet terminal, a laptop computer, and other portable electronic devices on which a certain application is installed.

It should be noted that while the drawing illustrates one of each of a set of an onboard navigation device 10 and a vehicle 60a and a set or a portable terminal 20 and a vehicle 60b, there is no particular limit to the number of these sets. In addition, in the below description, when not making any distinction between the vehicle 60a in which the onboard navigation device 10 is installed and the vehicle 60b driven by the user of the portable terminal 20, the alphabetic characters at the end are omitted, and the vehicle is referred to simply as “vehicle 60”.

The traffic information analysis device 30 is a device that performs a detailed analysis based on the location information of each vehicle 60 that are mobile bodies, as a process specific to the first embodiment.

Specifically, the traffic information analysis device 30 acquires the location information of each vehicle 60 from the onboard navigation device 10 and the portable terminal 20. In addition, based on the location information of each vehicle 60, the traffic information analysis device 30 creates a visit information database storing data regarding visits of each vehicle 60 to facilities. In addition, the traffic information analysis device 30 stores map information including roads on which each vehicle 60 can travel and locations of facilities each vehicle 60 can visit.

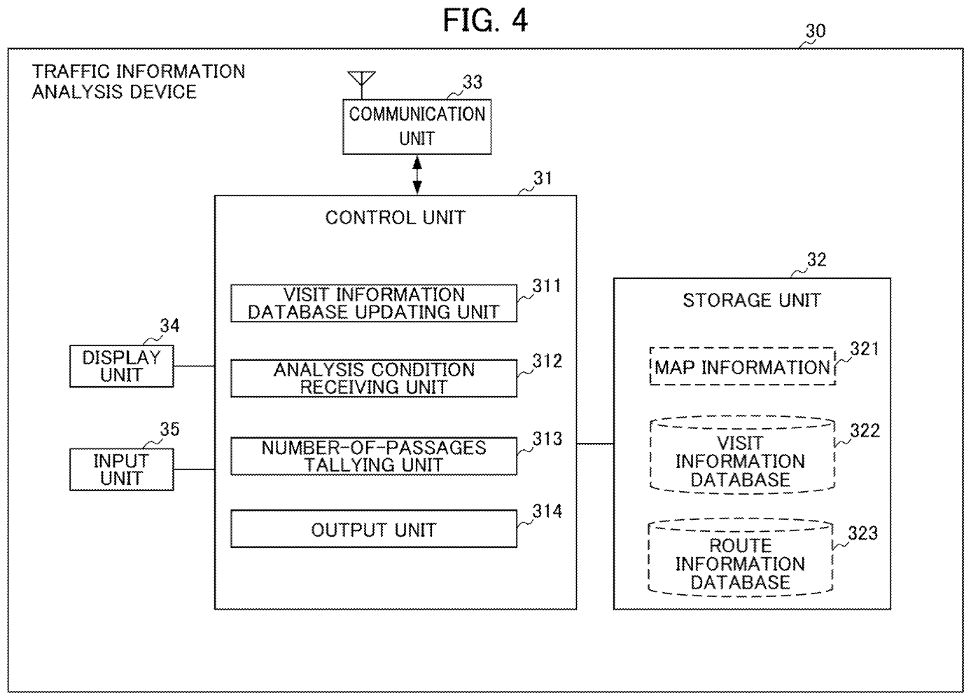

Further, the traffic information analysis device 30 receives, from a user using the analysis information, analysis conditions that are inputted in order to obtain analysis information according to conditions desired by the user. The analysis conditions mentioned here are conditions including a designation of a predetermined location or predetermined section of a road to be the target of the analysis in order to generate the analysis information. The details of the analysis conditions will be described later with reference to FIG. 4.

The, the traffic information analysis device 30 performs analysis according to the received analysis conditions based on information in the visit information database and the map information. For example, the traffic information analysis device 30 determines the predetermined location or predetermined section of a road designated in the analysis conditions as the analysis target. In addition, based on the information in the visit information database and the map information, the traffic information analysis device 30 identifies vehicles 60 that have passed a road (hereinafter referred to as “designated road”) adjacent to the determined predetermined location or predetermined section within a predetermined period.

The traffic information analysis device 30 identifies movement routes of the vehicles 60 that have been identified as having passed the designated road within the predetermined period. Based on the information in the visit information database and the movement routes of the vehicles 60, the traffic information analysis device 30 tallies the number of passages for each vehicle 60 that has passed the designated road within the predetermined period and/or the number of vehicles 60 for each number of passages.

In this way, by comparing the number and/or ratio of the vehicles 60 for each number of passages based on the information such as location information acquired from the vehicles 60 that are mobile bodies, the traffic information analysis device 30 can determine if the designated road is a road with many customers (vehicles) with a low number of passages (in other words, who normally do not pass by there), or a road with many customers (vehicles) with a high number of passages (in other words, who pass by there often, such as when commuting, etc.).

This allows the traffic information analysis device 30 to analyze, based on the number and/or ratio for each number of passages on the designated road, the respective effectiveness of a sign aimed at chance customers who normally do not pass by there (non-locals) and a sign aimed at locals who pass by often, to deem which sign would be suitable as a sign to position along the designated road.

In addition, the traffic information analysis device 30 presents analysis information computed in this way to a user. In other words, the user can obtain analysis information regarding a facility the user him- or herself has designated as an analysis target.

The user can use this analysis information presented by the traffic information analysis device 30 for various applications.

For example, since the traffic information analysis device 30 displays the number and/or ratio of the vehicles 60 for each number of passages on the designated road in a comparable manner, effectiveness analysis of either a sign aimed at non-locals (chance customers) or a sign aimed at locals is possible.

Moreover, the user using the analysis information of the first embodiment may be, for example, a business operator managing a store, or a consultant performing consulting with respect to the business operator. In other words, the analysis information of the first embodiment can be used by various users in various ways.

Such a traffic information analysis device 30 can be realized by incorporating software for realizing the first embodiment in, for example, a server device or a personal computer.

The communication network 50 is realized by a network such as the Internet and a mobile phone network, and a network combining these. In addition, part of the network may include a local area network (LAN).

The vehicle 60 is a mobile body having the onboard navigation device 10 or a user with a portable terminal 20. The vehicle 60 is realized by, for example, a four-wheeled car, a two-wheeled motorcycle, a bicycle, etc.

### <Functional Blocks of the Onboard Navigation Device 10>

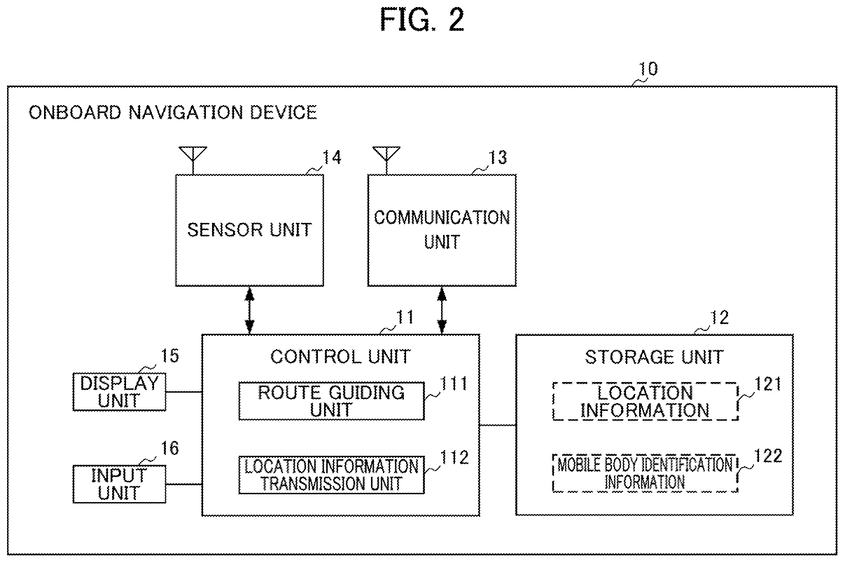

Next, the functional blocks of the onboard navigation device 10 will be described with reference to the block diagram of FIG. 2.

Here, the onboard navigation device 10 is supplied with power from the vehicle 60a, and is automatically activated when the ignition switch of the vehicle 60a is turned on (the engine is started) by the user driving the vehicle 60a. The onboard navigation device 10 remains in operation until the ignition switch of the vehicle 60a is turned off (the engine is stopped) by the user driving the vehicle 60a.

As shown in FIG. 2, the onboard navigation device 10 includes a control, unit 11/ a storage unit 12, a communication unit 13, a sensor unit 14, a display unit 15, and an input unit 16.

The control unit 11 is constituted by a processing device such as a microprocessor, and controls each unit constituting the onboard navigation device 10. The details of the control unit 11 will be described later.

The storage unit 12 is constituted by a semiconductor memory or the like, and stores various programs such as a control program called firmware or operating system, a program for performing a route guiding process, and a program for performing a transmission process of location information to the traffic information analysis device 30, and further stores various kinds of information such as map information, etc. The drawing illustrates information stored by the storage unit 12, location information 121 and mobile body identification information 122, which are particularly related to the transmission process of the location information.

The location information 121 is location information of the onboard navigation device 10 (in other words, location information of the vehicle 60a) measured by the sensor unit 14 described later. The location information 121 is configured to include not only information indicating a measured location, but also the time at which measuring was performed.

In addition, the mobile body identification information 122 is information for identifying the onboard navigation device 10. For example, a serial number or the like which is uniquely assigned to the onboard navigation device 10 may be used as the mobile body identification information 122. In addition, it is also possible to use as the mobile body identification information 122 a telephone number given to a subscriber identity module (SIM) inserted into the communication unit 13 to allow the communication unit 13 to connect to the communication network 50, which is a network such as a mobile phone network. In addition, it is also possible to use as the mobile body identification information 122 a unique vehicle identification number (VIN) given to the vehicle 60a, or the license number.

The various kinds of information stored in the storage unit 12 may be stored in the storage unit 12 in advance, or downloaded as necessary from a server device (not shown) or the like connected to the communication network 50. Further, the information may be modified as necessary in response to an input from the user, etc.

The communication unit 13 has a digital signal processor (DSP), and realizes wireless communication with other devices (for example, the traffic information analysis device 30) connected to the communication network 50 according to standards such as 3^{rd} Generation (3G), Long Term Evolution (LTE), 4^{th} Generation 4G), or Wi-Fi(R). The communication unit 13 is used, for example, to allow a location information transmission unit 112 described later to transmit the location information 121 and the mobile body identification information 122 stored in the storage unit 12 to the traffic information analysis device 30. However, there is no particular limitation on data transmitted and received between the communication unit 13 and other devices, and information other than the location information 121 and the mobile body identification information 122 may be transmitted and received.

The sensor unit 14 is constituted by, for example, a global positioning system (GPS) sensor, a gyro sensor, an acceleration sensor, etc. The sensor 14 has a function as a location detection unit that detects location information, receives a GPS satellite signal by the GPS sensor, and measures the location information (latitude and longitude) of the onboard navigation device 10. Measuring by the sensor unit 14 is performed as described above at a predetermined time interval (for example, every three seconds). The measured location information is stored in the storage unit 12 as location information 121.

In addition, the sensor unit 14 is capable of further increasing the measuring accuracy of the location information of the onboard navigation device 10 based on an angular velocity and acceleration measured by the gyro sensor and the acceleration sensor.

In addition, when GPS communication is difficult or impossible, the sensor unit 14 can use assisted global positioning system (AGPS) communication to compute the location information of the onboard navigation device 10 by means of base station information acquired from the communication unit 13.

The display unit 15 is constituted by a display device such as a liquid crystal display or an organic electroluminescent panel, etc. The display unit 15 displays an image upon receiving an instruction from the control unit 11. Information displayed by the display unit 15 may include, for example, the current location of the onboard navigation device 10, map information nearby the current location of the onboard navigation device 10 which is read out from the map information, a destination set by the user, appointment information notified from another onboard navigation device 10, route information, and various user interfaces, etc.

The input unit 16 is constituted by an input device (not shown) such as a physical switch called a ten key, or a touch panel provided in a state of being superimposed on a display surface of the display unit 15. An operation such as a selection operation by the user and enlargement or reduction of a map can be performed by outputting a signal based on an operation input from the input unit 16, for example, pressing of the ten key or touching on the touch panel by the user to the control unit 11.

It should be noted that, although not shown in the drawings, a speaker and a microphone may be provided. The speaker outputs a voice to a driver, and the microphone collects a voice or the like uttered by the driver. This allows for information to be outputted as a voice from the speaker, and for various selections and instructions inputted as a voice by the driver through the microphone to be inputted into the control unit 11 by voice recognition technology.

Next, the details of the control unit 11 will be described. The control unit 11 is constituted by a microprocessor having a central processing unit (CPU), a random-access memory (RAM), a read-only memory (ROM), an input/output (I/O), and the like. The CPU executes each program read out from the ROM or the storage unit 12, reads out information from the RAM, the ROM, and the storage unit 12 in execution of the program, writes the information in the RAM and the storage unit 12, and transmits and receives a signal to and from the communication unit 13, the sensor unit 14, the display unit 15, and the input unit 16. Thus, the process of the first embodiment is realized by hardware and software (programs) cooperating in this way.

The control unit 11 includes as a functional block a route guiding unit 111 and a location information transmission unit 112.

The route guiding unit 111 is a unit which performs a route guiding process to a destination such as a facility, etc. inputted or selected by the user.

The route guiding process to the destination is equivalent to a route guiding process in general car navigation systems. That is to say, the route guiding unit 111 can perform route guiding by generating a map to the destination based on the map information (not shown) stored in the storage unit 12, superimposing the current location of the onboard navigation device 10 measured by the sensor 14, the location of the destination, and route information to the destination on this map, and displaying this on the display unit 15. In this case, a voice for the route guiding may further be outputted from the speaker not shown in the drawings. In addition, information on traffic congestion of a road and information on the weather may be acquired through communication by the communication unit 13, and the acquired information may be used in the route guiding process.

Since the route guiding process to the destination is well known to those skilled in the art, further detailed description thereof is omitted. In addition, since the map information for performing the route guiding process is also well known to those skilled in the art, further detailed description and illustration thereof is omitted.

The location information transmission unit 112 is a unit which transmits the location information 121 and the mobile body identification information 122 stored in the storage unit 12 to the traffic information analysis device 30 through wireless communication using the communication unit 13.

Transmission of the location information 121 and the mobile body identification information 122 to the traffic information analysis device 30 by the location information transmission unit 112 is performed periodically, from when the ignition switch of the vehicle 60a is turned on (the engine is started) by the user of the vehicle 60a and the onboard navigation device 10 is automatically activated, until when the ignition switch of the vehicle 60a is turned off (the engine is stopped). Transmission is performed in real time, for example, whenever the sensor unit 14 performs a measurement at a predetermined interval (for example, every three seconds). Alternatively, instead of transmitting to the traffic information analysis device 30 in real time, a plurality of pieces of information (for example, the location information 121 and the mobile body identification information 122 of a three-minute period, updated every three seconds) may be transmitted at a time. That is to say, so-called burst transmission is possible. The length of the predetermined time interval, and whether to transmit in real time or with burst transmission may be freely set according to the environment to which the first embodiment is to be applied.

By performing real-time transmission or burst transmission in this way, the location information transmission unit 112 transmits the location information 121 for identifying a movement route of the vehicle 60a measured by the sensor unit 14 and the mobile body identification information 122 to the traffic information analysis device 30.

In this case, a location that is identified by the location information 121 measured immediately after the ignition switch has been turned on (the engine has been started) and the onboard navigation device 10 has automatically activated can be transmitted to the traffic information analysis device 30 as a first vehicle location, in other words, a departure location. Further, a location that is identified by the location information 121 measured immediately before the ignition switch is turned off (the engine is stopped) can be transmitted to the traffic information analysis device 30 as a final vehicle location, in other words, a parking location.

In this case, activation information indicating that the location information 121 represents the departure location and stopping information indicating that the location information 121 represents the parking location may be added to the location information 121 before transmission to the traffic information analysis device 30. For example, transmission may be performed with a flag indicating activation information set to 1 and a flag indicating stopping information set to 1. Moreover, the location information 121 (in other words, the parking location) measured immediately before the ignition switch is turned off (the engine is stopped) may be transmitted when the ignition switch is turned on (the engine is started) and the onboard navigation device 10 is re-activated.

In addition, even in case burst transmission is performed, if it has been determined by the route guiding unit 111 that the vehicle 60a has arrived at the destination (for example, a certain facility), the location information transmission unit 112 may switch to real-time transmission. By doing this, it is possible to prevent a situation where, after arriving at a certain facility, the ignition switch is turned off (the engine is stopped) before the location information 121 of the parking location is transmitted and the location information 121 of the destination such as the facility, etc. is not transmitted to the traffic information analysis device 30.

### <Functional Blocks of the Portable Terminal 20>

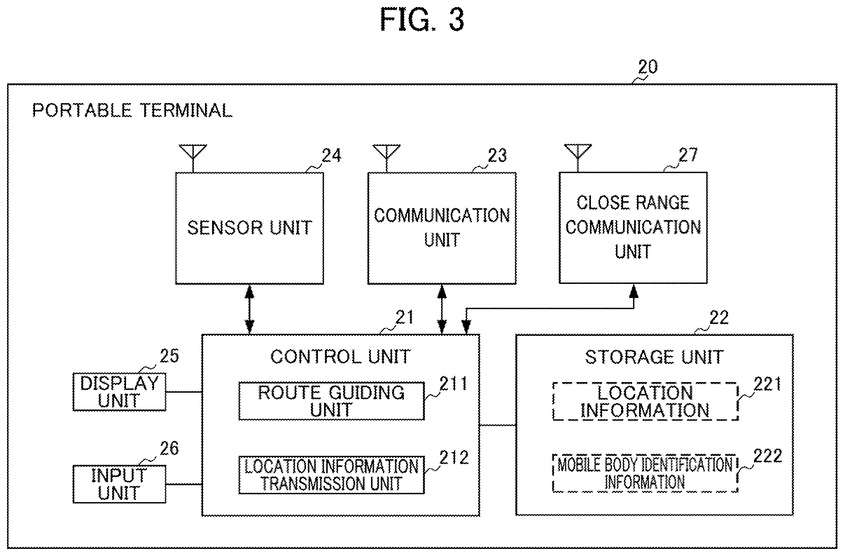

Next, the functional blocks of the portable terminal 20 will be described with reference to the block diagram of FIG. 3.

Here, while the onboard navigation device 10 described above is supplied with power from the vehicle 60a, the portable terminal 20 is supplied with power from its own battery (not shown). However, the portable terminal 20 may be supplied with power from a cigar lighter socket or the like of the vehicle 60b in order to charge the battery,

As shown in FIG. 3, the portable terminal 20 includes a control unit 21, a storage unit 22, a communication unit 23, a sensor unit 24, a display unit 25, an input unit 26, and a close-range communication unit 27.

Here, the control unit 21, the storage unit 22, the communication unit 23, the sensor unit 24, the display unit 2 and the input unit 26 have the same functions as the functional blocks with the same names of the onboard navigation device 10 described above. In other words, as the functional blocks of the portable terminal 20 can be described by replacing the term “onboard navigation device 10” with the term “portable terminal 20” in above description of the onboard navigation device 10, redundant descriptions are omitted.

On the other hand, the portable terminal 20 differs from the onboard navigation device 10 in that it includes the close-range communication unit 21, so this difference will be described below.

The close-range communication unit 27 is a unit for performing contactless close-range communication according to standards such as Near Field Communication (NFC) and Bluetooth(R), or wired close-range communication through a Universal Serial Bus (USB) cable or the like.

Meanwhile, the vehicle 60b includes a close-range communication unit for communicating with the close-range communication unit 27. For example, an Electronic Control Unit (ECU) of the vehicle 60b includes a close-range communication unit.

As such, a case in which the portable terminal 20 is capable of communicating with the ECU through close-range communication is thus a case in which the portable terminal 20 is present in the interior of the vehicle 60b. In this case, location information measured by the sensor unit 24 of the portable terminal 20 corresponds to the location information of the vehicle 60b.

While the portable terminal 20 is capable of close-range communication with the ECU via the close-range communication unit 27, the portable terminal 20 activates a location information transmission unit 212. The activated location information transmission unit 212, like the location information transmission unit 112 of the onboard navigation device 10, transmits location information 221 for identifying a movement route of the vehicle 60b measured by the sensor unit 24 and mobile body identification information 222 to the traffic information analysis device 30. Moreover, as in the case of the onboard navigation device 10, the location information 121 is configured to include not only information indicating a measured location, but also the time at which measuring was performed.

For example, when the user holding the portable terminal 20 gets on the vehicle 60b and turns on the activation switch such as the ignition switch of the vehicle 60b, the vehicle 60b and the portable terminal 20 are connected (paired), and the location information 221 measured by the portable terminal 20 and the mobile body identification information 222 are transferred from the portable terminal 20 to the traffic information analysis device 30. In this case, a location that is identified by the location information 121 measured immediately after pairing of the vehicle 60b and the portable terminal 20 may be transferred to the traffic information analysis device 30 as a first vehicle location, in other words a departure location.

Further, when the activation switch such as the ignition switch of the vehicle 60b is turned off, the pairing of the vehicle 60b and the portable terminal 20 is disconnected. In this case, a position that is identified by the location information 121 measured immediately before disconnection may be transferred to the traffic information analysis device 30 as a final vehicle location, in other words a parking location.

In this case, as in the case of the location information 112, information may be transferred in real time or using burst transmission, burst transmission may be switched to real-time transmission when it has been determined that the parking location has been reached, activation information or stopping information may be added to indicate that the vehicle is at the departure location or the parking location, and the parking location may be transferred at a time of re-activation.

Moreover, in case the vehicle 60b has a function of measuring location information, the location information measured by the vehicle 60b may be transferred as the location information 121 to the traffic information analysis device 30 instead of the location information measured by the sensor unit 24. In this case, the sensor unit 24 may be omitted from the portable terminal 20.

### <Functional Blocks of the Traffic Information Analysis Device 30>

Next, the functional blocks of the traffic information analysis device 30 will be described with reference to the block diagram of FIG. A.

As shown in FIG. 4, the traffic information analysis device 30 includes a control unit 31, a storage unit 32, and a communication unit 33.

The control unit 31 is constituted by a processing device such as a microprocessor and controls each unit constituting the traffic information analysis device 30. The details of the control unit 31 will be described later.

The storage unit 32 is constituted by a semiconductor memory or the like, and stores various programs such as a control program called firmware or operating system and a program for performing an Information analysis process, and further stores various kinds of information such as map information, etc. The drawing illustrates information stored by the storage unit 32, map information 321, a visit information database 322, and a route information database 323 which are particularly related to the analysis process of the location information.

The map information 321 includes various information, such as information on features like a road and a facility, road information, facility location information, parking lot location information, and the like. In addition, the map information 321 also includes display map data for displaying backgrounds such as a road and a road map, location information of nodes (for example, an intersection, a bend point, an end point, and the like of a road) and type information thereof, location information of a link that is a route connecting respective nodes and type information thereof and road network data including link cost data relating to cost information of all links (for example, a distance, required time, and the like), etc.

Information of a so-called road map such as a location and shape of a road/ the type of the road, locations of traffic signals, etc. is stored as the road information.

Location information of each facility is stored in the form of latitude and longitude information as the facility location information. In addition, the facility location information may include additional information such as a facility's mobile body identification information (facility ID), name, facility type (and/or genre), telephone number, address, business hours, menu provided if the facility is a restaurant, facility information relating to goods and services, etc.

Location information of a parking lot is stored in the form of latitude and longitude as the parking lot information. If a parking lot is a parking lot of a respective facility, the facility and the parking lot are stored in association with each other.

The map information 321 may be stored in the storage unit 32 in advance, or downloaded as necessary from a server device (not shown) or the like connected to the communication network 50. Further, the information may be modified as necessary in response to an input from the user, etc.

The visit information database 322 is a database constructed based on the location information 121 and mobile body identification information 122 and the location information 221 and mobile body identification information 222 received respectively from the onboard navigation device 10 and the portable terminal 20. The visit information database 322 is constructed by a visit information database updating unit 311 described later. The details of the visit information database 322 will be described later when describing the visit information database updating unit 311. It should be noted that in the following description, when not making any distinction between the location information 121 and the location information 221, the reference numerals are omitted, and the information is referred to as “location information”. In addition, when not making any distinction between the mobile body identification information 122 and the mobile body identification information 222, the reference numerals are omitted, and the information is referred to as “mobile body identification information”.

The route information database 323 is a database of movement routes for each vehicle 60, created by the number-of-passages tallying unit 313 described later based on the visit information database 322. The details of the route information database 323 will be described later when describing the number-of-passages tallying unit 313.

The communication unit 33 has a DSP or the like, and realizes wireless communication with other devices via the communication network 50 according to standards such as 3G, LTE, 4G, or Wi-Fi(R). The communication unit 33 is used, for example, to receive the location information and the mobile body identification information transmitted respectively from the onboard navigation device 10 and the portable terminal 20.

However, there is no particular limitation on data transmitted and received between the communication unit 33 and other devices, and information other than this information may be transmitted and received.

Next, the details of the control unit 31 will be described. The control unit 31 is constituted by a microprocessor having a CPU, a RAM, a ROM, an I/O, and the like. The CPU executes each program read out from the ROM or the storage unit 32, reads out information from the RAM, the ROM, and the storage unit 32 in execution of the program, writes the information in the RAM and the storage unit 32, and transmits and receives a signal to and from the communication unit 33, a display unit 34, and an input unit 35. Thus, the process of the first embodiment is realized by hardware and software (programs) cooperating in this way.

In this way, the control unit 31 executes each program to cause the traffic Information analysis device 30 to function as a predetermined unit (hereinafter referred to as “traffic information analysis control unit”).

In addition, the control unit 31 executes each program to cause the traffic Information analysis device 30 in the form of a computer to execute a predetermined step (hereinafter referred to as “traffic information analysis control step”). Hereinafter, the functions of the control unit 31 will be described from the perspective of the traffic information analysis control unit, it should be noted that since a description from the perspective of the traffic information analysis control step (method) is possible by replacing the term “unit” with the term “step”, this description is omitted.

The control unit 31 includes as functional blocks a visit information database updating unit 311, an analysis condition receiving unit 312, the number-of-passages tallying unit 313, and an output unit 314.

The visit information database updating unit 311 is a unit which constructs the visit information database 322 and appropriately updates the visit information database 322. An example of the data structure of the visit information database 322 will be described with reference to FIG. S.

### <Visit Information Database 322>

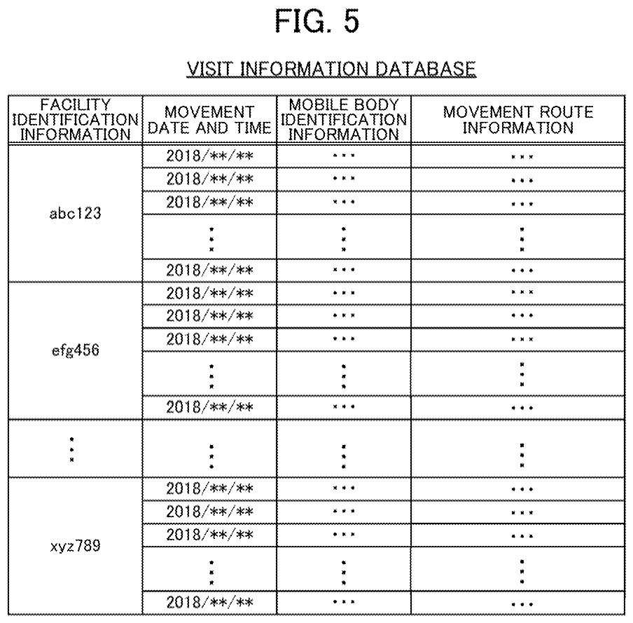

As shown in FIG. 5, the visit information database 322 includes “facility identification information” for identifying a facility a vehicle 60 has visited. In addition, the visit information database 322 includes “mobile body identification information” received from the onboard navigation device 10 and the portable terminal 20 of a vehicle 60 that has visited a facility corresponding to the facility identification information. Further, the visit information database 322 includes a “movement date and time” and “movement route information” identified by the visit information database updating unit 311 based on the “location information” received from the onboard navigation device 10 and the portable terminal 20 of the vehicle 60 that has visited a facility corresponding to the facility identification information. The visit information database updating unit 311 stores each of these pieces of information in corresponding fields in the visit information database 122 to construct and update the visit information database 322.

The “facility identification information” in the visit information database 322 is information for identifying a facility the vehicle 60 has visited, and is acquired from the above map information 321. For example, numbers or letters uniquely assigned to the facility, a facility's name, a facility's telephone number, or the like may be used as the facility identification information.

The “movement date and time” in the visit information database 322 is information indicating the date and time at which the vehicle 60 corresponding to the mobile body identification information has moved. In the first embodiment, one movement is considered to be, for example, a duration from when transmission of location information from any onboard navigation device 10 or portable terminal 20 has been started until the transmission ends. A date and time corresponding to this one movement is stored as the movement date and time in the visit information database 322.

The “mobile body identification information” in the visit information database 322 is, as described above, information for identifying the onboard navigation device 10 or portable terminal 20 which is the sender of the location information. In other words, it is information for identifying the vehicle 60 corresponding to the onboard navigation device 10 or portable terminal 20.

The “movement route information” in the visit information database 322 is information indicating a movement route identified based on all the location information changing in a time-discrete manner received during one movement. Additionally, as described above, the location information includes not only information indicating a measured location, but also the time at which measuring was performed. The visit information database updating unit 311 can identify the movement route of the vehicle 60 by connecting the location information that changes in a time-discrete manner.

In addition, by using the location information and the time information, the average velocity when passing each road link, which is a route connecting nodes (for example, an intersection, a bend point, an end point, and the like of a road) on the movement route, can be computed by dividing the time required to pass each road link and the distance of the road link by the time required to pass the road link. If the accuracy of the location information is low in the environment in which the first embodiment is implemented, the visit information database updating unit 311 may be configured to perform map matching that cross-references the map information 321 with the location information in order to identify the movement route. However, if the accuracy of the location information is high, map matching may not be absolutely necessary.

<Visit information Database Updating Unit 311>

Whenever transmission of location information and mobile body identification information from any onboard navigation device 10 or portable terminal 20 has been started and then ended, the visit information database updating unit 311 stores each piece of information described above in a new field based on the received location information and mobile body identification information to update the visit information database 322.

In addition, in order to construct and update the visit information database 322, the visit information database updating unit 311 needs to identify which vehicle 60 has visited which facility.

In order to do this, the visit information database updating unit 311 identifies, based on the received location information, a location at which the user parked the vehicle 60. For example, if the location information includes information indicating a parking location as described above, the parking location is identified based on this information. Alternatively, in the event that the location information does not include information indicating a parking location, the parking location can be considered to be, for example, a location corresponding to the location information received last in a duration from the start of the transmission of location information until the end, or a location that has not changed for a predetermined length of time.

The visit information database updating unit 311 then compares the identified parking location to the location of each facility included in the map information 321 (and locations of parking lots associated with the facilities), and in case the identified parking location matches the location of any facility (and location of a parking lot associated with the facility), it is determined that the vehicle 60 has visited the matching facility. It also determines that the location information corresponding to the parking location in the outward route has been received before receiving it. The degree of “matching” of the parking location and the location of the facility may be set freely. For example, in a case where the onboard navigation device 10 or portable terminal 20 can measure the location information accurately, the range in which a match is determined may be made narrow. On the other hand, in a case where the onboard navigation device 10 or portable terminal 20 cannot measure the location Information very accurately, the range in which a match is determined may be made wide. In other words, a match may be determined even in cases where the locations are slightly misaligned. In addition, the user of the traffic information analysis device 30 may modify the visit information database 322 as necessary.

### <Analysis Condition Receiving Unit 312>

The analysis condition receiving unit 312 is a unit which receives analysis conditions. As described above, analysis conditions are conditions inputted (or set) by the user to obtain desired analysis information. The analysis condition receiving unit 312 generates a user interface for receiving an input (or setting) operation of analysis conditions from the user, and causes the display unit 34 realized by a display to display the generated user interface. The user refers to the user interface and inputs the analysis conditions using the input unit 35, which receives inputs from an input interface such as a keyboard or mouse, etc.

Here, the analysis conditions include, for example, a designation of predetermined location or predetermined section of a road which is to be the analysis target. The predetermined section is, for example, a road link, and the predetermined location is a location on the map. In addition, the analysis conditions may also include a designation of analysis method, a designation relating to a range of roads that can be designated as analysis targets or a designation relating to a period subject to analysis, a designation relating to a day subject to analysis (for example, a weekday, a holiday, a business day, etc.), a designation relating to a time period subject to analysis, a designation of a predetermined unit subject to analysis, etc. Here, the predetermined unit is any unit appropriately set according to the predetermined section or predetermined location, for example, per day, per weekday/holiday, per hour, per time period, etc.

The analysis condition receiving unit 312 directly or indirectly provides the input analysis conditions to the number-of-passages tallying unit 313 and the output unit 314.

<Number-of-passages tallying Unit 313>

Based on the map information 321, the number-of-passages tallying unit 313 identifies the predetermined section or predetermined location designated as the analysis target in the analysis conditions inputted from the analysis condition receiving unit 312, and identifies a designated road (a road adjacent to the predetermined section or the predetermined location).

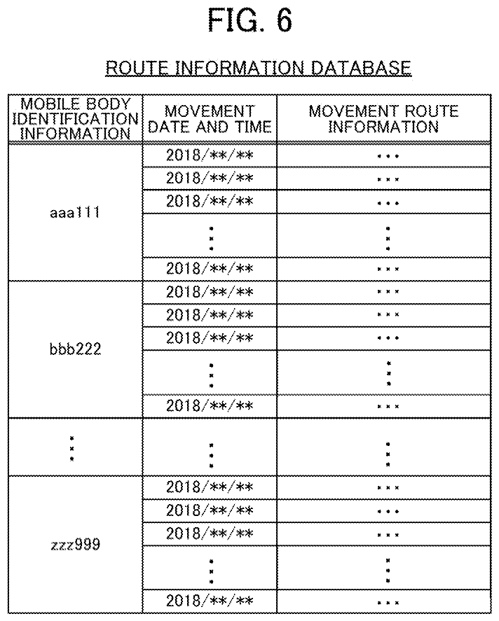

In addition, the number-of-passages tallying unit 313 generates a route information database 323 in order to tally the number of passages for each vehicle 60 that has passed the designated road and the number of vehicles 60 for each number of passages. An example of the data structure of the route information database 323 will be described with reference to FIG. 6.

### <Route Information Database 323>

As shown in FIG. 6, the route database 323 includes “mobile body identification information”, “movement date and time”, and “movement route information”, and includes a “movement date and time” and “movement route information” for each “mobile body identification information” of vehicles 60 that have passed the designated road (a road adjacent to the predetermined section or predetermined location) within a predetermined period.

The number-of-passages tallying unit 313 references the visit information database 322 to identify, for example, a vehicle 60 that has passed the designated road within the predetermined period designated as the analysis target in the analysis conditions, and identify the movement route of the identified vehicle 60.

Next, based on the “movement date and time” and “movement route information” in the visit information database 322, the number-of-passages tallying unit 313 creates the route information database 323 by rearranging the “movement date and time” and “movement route information” for each “mobile body identification information” of vehicles 60 that have passed the designated road (a road adjacent to the predetermined section or predetermined location) within the predetermined period.

Further, if the analysis conditions designate a plurality of road sections or a plurality of designated locations, the number-of-passages tallying unit 313 creates a route information database 323 for each designated road section or designated location.

The number-of-passages tallying unit 313 may also be configured to compute the number of passages of the designated road for each direction in which the road is passed (for example, an ascending direction, a descending direction, etc.). In that case, it is possible to compute the number of passages of the designated road for each direction in which the designated road is passed (for example, an ascending direction, a descending direction, etc.) by identifying a case in which the designated road is passed in the ascending direction and a case in which the designated road is passed in the descending direction.

In addition, the route information database 323 may be created each time the traffic information analysis device 30 executes the analysis process and deleted each time the traffic information analysis device 30 ends the analysis process.

In this way, by referencing the route information database 323, the number-of-passages tallying unit 313 tallies the number of passages for each vehicle 60 that has passed the designated road within the predetermined period, and the unit number of vehicles 60 for each number of passages. If a vehicle 60 has passed the designated road a plurality of times in one movement route from departure to arrival at the destination, the number-of-passages tallying unit 313 may include this plurality of times in the number of passages.

Then, based on the number of passages for each vehicle 60 that has passed the designated road within the predetermined period and/or the unit number of vehicles 60 for each number of passages, the number-of-passages tallying unit 313 computes the number ratio for each number of passages having passed the designated road within the predetermined period. Further, if the analysis conditions designate a plurality of road sections and/or a plurality of designated locations, the number-of-passages tallying unit 313 may be configured to output a unit number and/or ratio for each number of passages (passage frequency) for each designated road section and/or each road adjacent to the designated locations. As described above, in the output, the number and/or ratio may be outputted for each number of passages for each direction (for example, an ascending direction, a descending direction, etc.) in which the designated road is passed.

### <Output Unit 314>

The output unit 314 outputs the number and/or ratio for each number of passages having passed the designated road (a road adjacent to the predetermined section or the predetermined location) within the predetermined period tallied by the number-of-passages tallying unit 313 to, for example, the display unit 34.

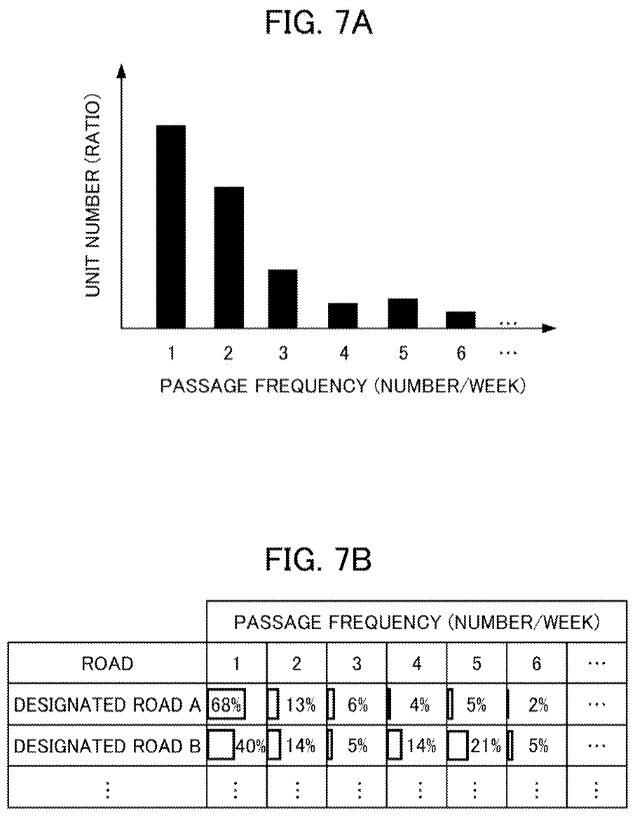

As shown in FIG. 7a, the unit number (ratio) for each number of passages (passage frequency) having passed the designated road is displayed, with the predetermined period set to, for example, one week.

Further, if the analysis conditions designate a plurality of road sections and/or a plurality of designated locations, the output unit 314 may be configured to output the number and/or ratio for each number of passages (passage frequency) for each of the plurality of road sections and/or each of the plurality of designated locations. In the output, the number and/or ratio may be outputted to the display unit 34 for each number of passages (passage frequency) for each direction (for example, an ascending direction, a descending direction, etc.) in which the designated road is passed.

FIG. 7B shows a display example in a case where the analysis conditions designate a plurality of road sections and/or a plurality of designated locations.

This makes it possible to have the number and/or ratio for each number of passages (passage frequency) be displayed in a manner that allows for comparison between roads, as shown in FIG. 7B.

In this way, the traffic information analysis device 30 allows the user to determine whether the designated road is a road with many vehicles with a low number of passages, or a road with many vehicles with a high number of passages.

Thus, since, for example, the traffic information analysis device 30 provides a comparable display for each designated road, it is possible to analyze which group to focus on as a target group for a sign depending on the designated road. This allows for effectiveness analysis of different signs, whereby, for example, if the designated road has a greater passage ratio of vehicles 60 with a low number of passages than a passage ratio of vehicles 60 with a high number of passages, a sign targeting, for example, chance customers who do not pass by often may be placed there. Conversely, if the ratio of vehicles 60 with a high number of passages is greater than the ratio of vehicles 60 with a low number of passages, a sign targeting, for example, locals who pass by often may be placed there.

An embodiment of each functional unit of the traffic information analysis system 1 according to the present invention has been described above based on the configurations of the onboard navigation device 10 installed in a vehicle 60, the portable terminal 20, and the traffic information analysis device 30. Moreover, the embodiments of the functional units of the traffic information analysis device 30 according to the present invention may be developed to be executed on one computer, or distributed across a plurality of computers being located in the same place or being distributed across several places and connected to one another via a communication network. In addition, the present invention may be configured using a plurality of virtual computers on a cloud.

### <Operation of the First Embodiment>

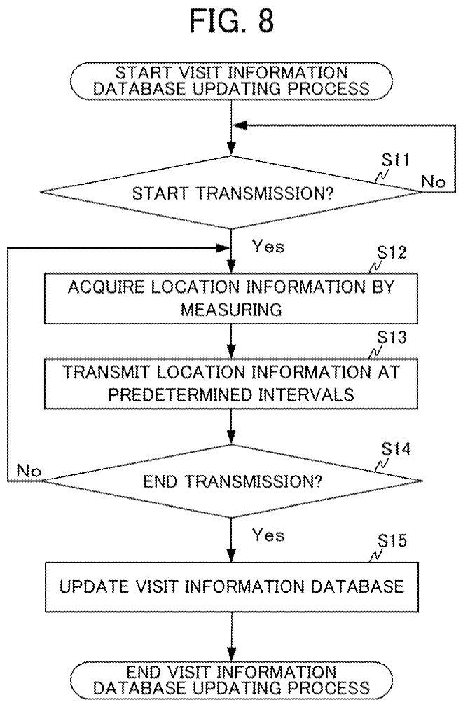

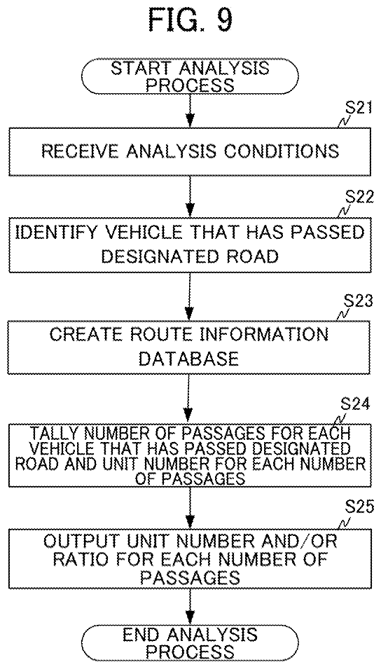

Next, an operation of the first embodiment will be described with reference to the flowcharts of FIG. 8 and FIG. 9. Here, FIG. 8 is a flowchart showing an operation at the time of collecting the location information and updating the visit information database 322, mainly performed by the visit information database updating unit 311. In addition, FIG. 9 is a flowchart showing an operation at the time of the analysis process performed by the analysis condition receiving unit 312, the number-of-passages tallying unit 313, and the output unit 314.

First, an operation of updating the visit information database 322 with location information collected from the onboard navigation device 10 will be described with reference to FIG. 8.

The location information transmission unit 132 determines whether or not to start transmission of the location information (Step S11). As described above, the transmission is started when the ignition switch of the vehicle 60a has been turned on. If the ignition switch is still turned off (No at Step S11), transmission by the location information transmission unit 112 is not started. On the other hand, if the ignition switch has been turned on (Yes at Step S11), the process advances to Step S12.

At Step S12, the sensor unit 14 acquires the location information by measuring the location of the onboard navigation device 10 (Step S12).

The location information transmission unit 112 acquires the location information from the sensor unit 14 and transmits the acquired location information to the traffic information analysis device 30 at predetermined intervals in real time or by burst transmission (Step S13).

Next, the location information transmission unit 112 determines whether or not to end transmission of location information (Step 314). As described above, the transmission ends if the ignition switch of the vehicle 60a has been turned off. If the ignition switch of the vehicle 60a remains turned on (No at Step S14), the measuring at Step S12 and the transmission at Step S13 are repeated.

On the other hand, if the ignition switch of the vehicle 60a has been turned off (Yes at Step S14), the process advances to Step S15.

At Step S15, the visit information database updating unit. 311 of the traffic information analysis device 30 updates the visit information database 322 based on the location information transmitted by the repetition of Step S12 and Step S13 (Step S15).

The operation described above realizes collection of location information and updating of the visit information database.

Next, an operation of updating the visit information database 322 with location information collected from the portable terminal 20 will be described with reference to FIG. 8. In this case, in the above description with reference to FIG. 7, it is enough to simply replace the location information transmission unit 112 with the location information transmission unit 212, the sensor unit 14 with the sensor unit 24, the criteria for Yes at Step S11 to “if the activation switch such as the ignition switch of the vehicle 60b is turned on and the vehicle 60b and the portable terminal 20 are paired”, and the criteria for Yes at Step S14 to “if the activation switch such as the ignition switch of the vehicle 60b has been turned off and the pairing between the vehicle 60b and the portable terminal 20 has been disconnected”. Accordingly, redundant descriptions are omitted.

Next, an operation at the time of the analysis process will be described with reference to FIG. 9.

First, at Step S21, the analysis condition receiving unit 312 receives analysis conditions from the user via the input unit 35, and outputs the received analysis conditions to the number-of-passages tallying unit 313, etc.

At Step S22, the number-of-passages tallying unit 313 identifies a vehicle 60 that has passed the designated road within the predetermined period, and identifies a movement route of the vehicle 60.

At Step S23, the number-of-passages tallying unit 313 creates a route information database 323 based on the movement route of the identified vehicle 60. (The database may be created based on the movement route for each direction (for example, an ascending direction, a descending direction, etc.) in which the designated road is passed.)

At Step S24, the number-of-passages tallying unit 313 references the route information database 323, and tallies the number of passages for each vehicle 60 that has passed the designated road within the predetermined period and the number ratio of vehicles 60 for each number of passages. (The number of passages for each vehicle 60 and the number ratio of vehicles 60 for each number of passages may be tallied for each direction (for example, an ascending direction, a descending direction, etc.) in which the designated road is passed.)

At Step S25, the output unit 314 outputs the tallied number and/or ratio for each number of passages to, for example, the display unit 34.

(The number and/or ratio for each number of passages (passage frequency) may be outputted to the display unit 34 for each direction (for example, and ascending direction, a descending direction, etc.) in which the designated road is passed.)

According to the operation of the first embodiment described above, the traffic information analysis device 30, based on information such as the location information of the vehicle 60 which is a mobile body, can determine, by comparing unit numbers and/or ratios of vehicles 60 for each number of passages, whether the designated road is a road with many (vehicles of) non-locals (chance customers) with a low number of passages or a road with many (vehicles of) customers with a high number of passages. Further, when placing a sign along the designated road, the traffic information analysis device 30 allows for an effectiveness analysis of respectively a sign aimed at non-locals (chance customers) or a sign aimed at locals, based on the number and/or ratio for each number of passages of the designated road. In addition, the result of such an analysis may be presented to a user. This concludes the description of the first embodiment.

### <Modified Example of the First Embodiment>

The number-of-passages tallying unit 313 according to the first embodiment tallies the number of passages for each vehicle 60 that has passed the designated road within the predetermined period and the unit number for each number of passages, but is not so limited. For example, as a modified example of the first embodiment, the number-of-passages tallying unit 313 may tally the number of passages for each vehicle 60 that has passed the designated road, and/or the unit number for each number of passages, with the predetermined period subject to analysis divided into weekdays and holidays, in this way, the traffic information analysis device 30 allows for an effectiveness analysis and a consideration of placement location of a sign targeting a road with a high ratio of vehicles with a high number of passages during weekdays (for example, commuter vehicles or business vehicles), or a sign targeting a road with a high ratio of vehicles with a low number of passages during holidays (for example, leisure vehicles, etc.).

### <Second Embodiment>

A traffic information analysis device according to a second embodiment has a home location identifying unit that identifies a home location that registers in advance or identifies from a tally of departure locations and/or arrival locations a home location for each vehicle 60, and the number-of-passages tallying unit 313 differs from the first embodiment in that it tallies the number of passages for each vehicle 60 of which the home location has been identified beyond a predetermined distance from the predetermined section or the predetermined location.

Hereinafter, the second embodiment will be described.

A traffic information analysis system according to the second embodiment, of the present invention includes the same configurations as the traffic information analysis system 1 according to the first embodiment shown in FIG. 1.

In addition, an onboard navigation device and a portable terminal according to the second embodiment also have the same configurations as the onboard navigation device 10 and the portable terminal 20 according to the first embodiment shown in FIG. 2 and FIG. 3.

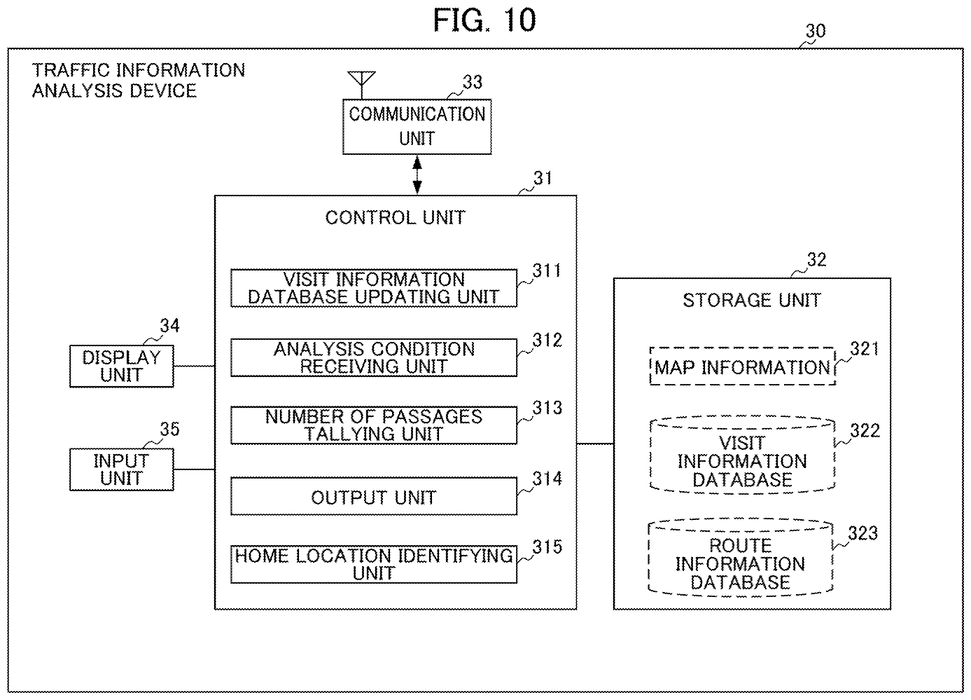

On the other hand, a traffic information analysis device according to the second embodiment has the same configurations as the traffic information analysis device 30 according to the first embodiment, but differs from the first embodiment in that it has a home location identifying unit 315, as shown in FIG. 10.

### <Functional Blocks of the Traffic Information Analysis Device 30>

The functional blocks of the traffic information analysis device 30 will be described with reference to the block diagram of FIG. 10. It should be noted that functional blocks having the same functions as in the block diagram of FIG. 4 are given the same reference numerals, and description thereof is omitted.

### <Home Location Identifying Unit 315>

The home location identifying unit 315 can identify a location registered in advance by the user of the vehicle 60 as a home location. Alternatively, the home location identifying unit 315 can reference the route information database 323, and, for example, based on the tally of departure locations from which the vehicle has first departed each day, if the departure location is frequently the same location, the home location identifying unit 315 can identify this departure location as the home location of the user (excluding car rental facilities). Alternatively, if, based on a tally of movements each day (particularly weekdays, etc.) in the past from the home to the same stopping location where the vehicle has stopped a long time and then set the stopping location as the departure location, the frequency of moving from the stopping location to the home is high, the home location identifying unit 315 may identify the user's workplace or school, etc. as the home location by cross-referencing the stopping location with map information.

In addition, the degree of “matching” of the same location may be set freely. For example, in a case where the onboard navigation device 10 or portable terminal 20 can measure the location information accurately, the range in which a match is determined may be made narrow. On the other hand, in a case where the onboard navigation device 10 or portable terminal 20 cannot measure the location Information very accurately, the range in which a match is determined may be made wide. In other words, stopping locations may be determined to match even in cases where the locations are slightly misaligned.

The home location identifying unit 315 may store the location of a home location (for example, home, workplace, school, etc.) of the user of each vehicle 60 identified for each vehicle 60 as a home location associated with the mobile body identification information in the route database 323. If the departure location is determined to be the location of a car rental facility, it may be registered as a “rental car”, as it is not the user's residence.

In this way, the number-of-passages tallying unit 313 receives a designation of the predetermined section or the predetermined location subject to analysis, and a designation of a predetermined distance from the predetermined section or the predetermined location as analysis conditions from the analysis condition receiving unit 312. The number-of-passages tallying unit 313 may reference the route information database 323 to tally the number of passages for each vehicle 60 and the unit number of vehicles 60 for each number of passages for vehicles with a home location beyond the predetermined distance among the vehicles 60 that have passed the designated road (a road adjacent to the predetermined section or the predetermined location).

Here, the predetermined distance may be any size. For example, a radius of N₁ km (where N₁ is any positive value) centered on the predetermined section or the predetermined location may be set as the predetermined distance. Alternatively, instead of a radius, the predetermined distance may be, for example, a range in which the movement distance of a vehicle 60 on a road to the predetermined section or the predetermined location is N₁ km. Alternatively, the predetermined distance may be determined, for example, based on a movement time required for a vehicle 60 to move to the predetermined section or the predetermined location. The predetermined distance may be set according to circumstances.

This allows the traffic information analysis device 30 to distinguish between a vehicle 60 of a local and a vehicle 60 of a non-local such as a leisure traveler from far away, and allows for effectiveness analysis and consideration of placement location of a sign targeting non-locals such as leisure travelers from far away by, for example, excluding locals.

### <Operation of the Second Embodiment>

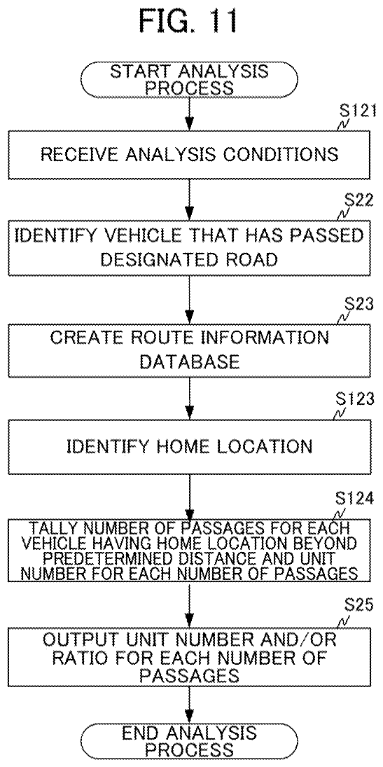

Next, an operation of the second embodiment will be described with reference to the flowchart of FIG. 11. It should be noted that since the updating process of the visit information database 322 in the second embodiment is the same as in the process of the first embodiment shown in FIG. 8, description thereof is omitted.

FIG. 11 is a flowchart showing an operation at a time of an analysis process performed by the analysis condition receiving unit 312, the number-of-passages tallying unit 313, the output unit 314, and the home location identifying unit 315. Further, in the flowchart of FIG. 11, processes identical to the steps shown in FIG. 9 are given the same step numbers, and detailed description thereof is omitted.

First, at Step S121, the analysis condition receiving unit 312 receives a designation of a predetermined section or a predetermined location and a designation of a predetermined distance from the predetermined section or the predetermined location as analysis conditions, and outputs the received analysis conditions to the number-of-passages tallying unit 313, etc.

At Step S22, the number-of-passages tallying unit 313 performs the same process as in Step S22 in the first embodiment to identify a vehicle 60 that has passed the designated road within the predetermined period, and to identify a movement route of the vehicle 60.

At Step S23, the number-of-passages tallying unit 313 performs the same process as in Step S23 in the first embodiment to create the route information database 323 based on the movement route of the identified vehicle 60.

At Step S123, the home location identifying unit 315 references the route information database 323 to identify a home location of the identified vehicle 60, and to identify a vehicle 60 of which the home location is beyond the predetermined distance from the designated road.

At Step S124, the number-of-passages tallying unit 313 tallies the number of passages for each identified vehicle 60 of which the home location identified at step S123 is beyond the predetermined distance and u unit number for each number of passages.

At Step S25, the output unit 314 performs the same process as in Step S25 in the first embodiment to output the tallied number and/or ratio for each number of passages to, for example, the display unit 34.

According to the operation of the second embodiment described above, the traffic information analysis device 30, based on the information such as location information of the vehicle 60, which is a mobile body, can distinguish between a vehicle 60 of a local and a vehicle 60 of a non-local such as a leisure traveler from far away, and by excluding the vehicle 60 of a local, allows for effectiveness analysis and consideration of placement location of a sign targeting non-locals such as leisure travelers from far away. In addition, the result of such an analysis way be presented to a user.

This concludes the description of the second embodiment.

### <Modified Example of the Second Embodiment>

The number-of-passages tallying unit 313 according to the second embodiment, tallies the number of passages for each vehicle 60 and the unit number of vehicles 60 for each number of passages for vehicles with a home location beyond the predetermined distance among the vehicles 60 that have passed the designated road (a road adjacent to the predetermined section or the predetermined location) within the predetermined period, but is not so limited. For example, as a modified example of the second embodiment, the number-of-passages tallying unit 313 may tally the number of passages for each vehicle 60 and the unit number of vehicles 60 for each number of passages for vehicles with a home location within the predetermined distance among the vehicles 60 that have passed the designated road (a road adjacent to the predetermined section or the predetermined location) within the predetermined period. In this way, the traffic information analysis device 30 can exclude a vehicle 60 of a non-local such as a leisure traveler from far away, allowing for effectiveness analysis and consideration of placement location of a sign targeting locals.

In addition, as described in the first embodiment, it is also possible in the second embodiment to compute and output the number and/or ratio for each number of passages (passage frequency) for each direction (for example, an ascending direction, a descending direction, etc.) in which the designated road is passed.

### <Third Embodiment>

A traffic information analysis device according to a third embodiment differs from the first embodiment in that the number-of-passages tallying unit 313 receives a designation of a facility as analysis conditions from the analysis condition receiving unit 312 rather than a predetermined section or a designated location, and has as a tallying target a predetermined section of a road identified by the movement route of a vehicle 60 that has passed a road adjacent to the designated facility.

Hereinafter, the third embodiment will be described.

A traffic information analysis system according to the third embodiment of the present invention includes the same configurations as the traffic information analysis system 1 according to the first embodiment shown in FIG. 1.

In addition, an onboard navigation device and a portable terminal according to the third embodiment also have the same configurations as the onboard navigation device 10 and the portable terminal 20 according to the first embodiment shown in FIG. 2 and FIG. 3.

On the other hand, a traffic information analysis device according to the third embodiment has the same configurations as the traffic information analysis device 30 according to the first embodiment, but differs from the first embodiment in that the number-of-passages tallying unit 313 receives a predetermined section to be a tallying target and a designation of a facility as analysis conditions from the analysis condition receiving unit 312.

Specifically, the number-of-passages tallying unit 313, based on the map information 321, identifies the predetermined section and facility subject to analysis designated by the analysis conditions inputted from the analysis condition receiving unit 312, and identifies a road adjacent to the predetermined section (road link) and the designated facility.

The number-of-passages tallying unit 313 references the visit information database 322 to identify, for example, a vehicle 60 which, within the predetermined period subject to analysis designated by the analysis conditions, on the way to the road adjacent to the designated facility has passed the predetermined section on a traffic flow road heading for the road adjacent to the designated facility.

Next, based on the “movement date and time” and the “movement route information” in the visit information database 322, the number-of-passages tallying unit 313 creates a route information database 323 by rearranging the “movement route information” and the “movement date and time” for each “mobile body identification information” of vehicles 60 that have passed the predetermined section on the way to passing the road adjacent to the designated facility within the predetermined period.

In this way, the number-of-passages tallying unit 313 references the created route information database 323 to tally the number of passages in the predetermined section for each vehicle 60 which has passed the predetermined section on the way to passing the road adjacent, to the designated facility within the predetermined period and the number of vehicles 60 for each number of passages in the predetermined section. In addition, based on the tallied number of passages in the predetermined section for each vehicle 60 and/or the unit number of vehicles 60 for each number of passages in the predetermined section, the number-of-passages tallying unit 313 computes the number ratio for each number of passages of the predetermined section on the way to passing the road adjacent to the designated facility within the predetermined period.

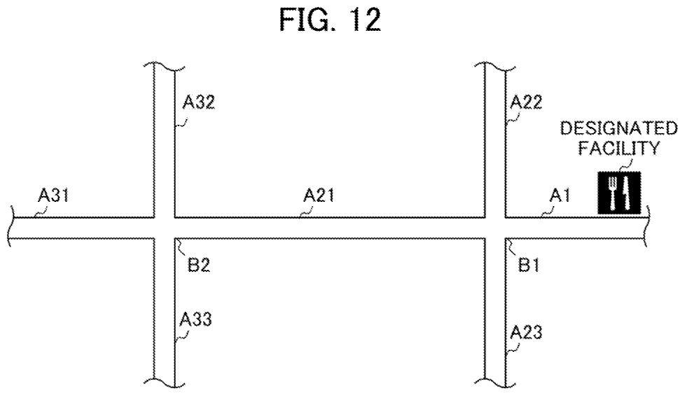

FIG. 12 shows an example of a relation between the road adjacent to the facility and the predetermined section. In general, a vehicle travels through a plurality of road links before arriving at the road adjacent to the designated facility. For example, a road A1 adjacent to the designated facility is connected to roads A21, A22, and A23 at intersection B1, and the road A21 is further connected to roads A31, A32, and A33 at intersection B2. In this case, the predetermined section is any of the roads A21, A22, A23, A31, A32, and A33.

The number-of-passages tallying unit 313 may have as tallying targets each of a plurality of road sections (road links) included in the movement route on the way to passing the road adjacent, to the designated facility of a vehicle 60 that has passed the road adjacent to the designated facility within the predetermined period, and may output the number and/or ratio for each number of passages (passage frequency) for each of the plurality of road sections (for example, the roads A21, A22, A23, A31, A32, A33).

In addition, by having the predetermined period subject to analysis be the business hours of a business day of the designated facility, the number-of-passages tallying unit 313 can, based on the movement routes of vehicles 60 that have passed through the predetermined section on the way to passing the road adjacent to the designated facility within the predetermined period, more accurately tally the number of passages in the predetermined section for each vehicle 60 and the unit number of vehicles 60 for each number of passages in the predetermined section. In addition, if the designated facility is, for example, a restaurant, then designating, for example, lunch time and/or dinner time, etc. as the time period allows for more appropriate tallying of the number of passages in the predetermined section for each vehicle 60 and unit number of vehicles 60 for each number of passages in the predetermined section.

In this way, by having the traffic flow roads of the designated facility be subject to processing, the traffic information analysis device 30 can tally the number and/or ratio for each number of passages in the predetermined section by identifying vehicles 60 that have passed the predetermined section on the way to passing the road adjacent to the designated facility, in order to facilitate consideration of which location of the traffic flow roads of the designated facility to place a sign in associated with the designated facility.

### <Operation of the Third Embodiment>

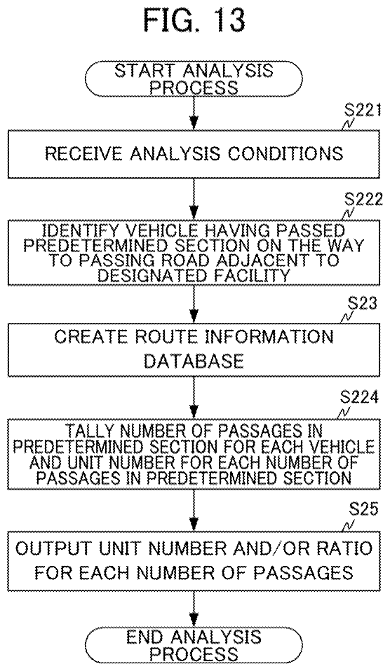

Next, an operation of the third embodiment will be described with reference to the flowchart of FIG. 13. It should be noted that since the updating process of the visit information database 322 in the third embodiment is the same as in the process of the first embodiment shown in FIG. 3, description thereof is omitted.

FIG. 13 is a flowchart showing an operation at a time of an analysis process performed by the analysis condition receiving unit 312, the number-of-passages tallying unit 313, and the output unit 314. Further, in the flowchart of FIG. 13, processes identical to the steps shown in FIG. 9 are given the same step numbers, and detailed description thereof is omitted.

First, at Step S221, the analysis condition receiving unit 312 receives a designation of a facility as analysis conditions, and outputs the received analysis conditions to the number-of-passages tallying unit 313, etc.

At Step S222, the number-of-passages tallying unit 313 identifies a vehicle 60 that has passed the predetermined section on the way to passing the road adjacent to the designated facility within the predetermined period.

At Step S23, the number-of-passages tallying unit 313 performs the same process as in Step S23 in the first embodiment to create the route information database 323 based on the identified vehicle 60.

At Step S224, the number-of-passages tallying unit 313 refers to the route information database 323 to tally the number of passages in the predetermined section for each vehicle 60 which has passed the predetermined section on the way to passing the road adjacent to the designated facility within the predetermined period and a unit number for each number of passages in the predetermined section.

At Step S25, the output unit 314 performs the same process as in Step S25 in the first embodiment to output the tallied number and/or ratio for each number of passages to, for example, the display unit 34.

According to the operation of the third embodiment described above, by having the traffic flow roads of the designated facility be subject to processing, the traffic information analysis device 30 can identify vehicles 60, which are mobile bodies, that have passed the predetermined section on the way to passing the road adjacent to the designated facility based on information such as location information of the vehicles 60, to tally the number and/or ratio for each number of passages in the predetermined section, thereby facilitating consideration of which location of the traffic flow roads of the designated facility to place a sign in associated with the designated facility. This concludes the description of the third embodiment.

### <Modified Examples>

Although the first to third embodiments described above are preferred embodiments of the present invention, the scope of the present invention is not limited only to the above embodiments, and the present invention may be worked in forms that apply various modifications without departing from the spirit and scope of the present invention. For example, the present invention may be worked in a form that applies modifications as in the modified examples described below.

For example, the functional configurations of FIG. 2, FIG. 3, FIG. 4, and FIG. 10 are merely examples, and do not limit the functional configurations of the first to third embodiments. That is to say, it is sufficient that the devices have functions capable of executing the series of processes relating to the information analysis function of the present invention as a whole, and what type of functional blocks to use in order to realize these functions is not limited to the examples particularly shown in FIG. 2, FIG. 3, FIG. and FIG. 10.

In addition, as another modified example, the onboard navigation device 10 and the portable terminal 20 may be realized by other devices that do not have a route guiding function. That is to say, the route guiding function of the onboard navigation device 10 and the portable terminal 20 is not essential. In this case, the traffic information analysis device 30 may further include a route guiding function, and route guiding may be performed by the traffic information analysis device 30 communicating with the onboard navigation device 10 or the portable terminal 20.

Further, as another modified example, although the traffic information analysis device 30 is described as being realized by one server device or the like in the above embodiments, a distribution processing system in which respective functions of the traffic information analysis device 30 are appropriately distributed to a plurality of servers may be employed. In addition, the respective functions of the traffic information analysis device 30 may be realized by using a virtual server function or the like on a cloud.

Further, as another modified example, a Floating Car Data (FCD) server (tentative name) may be provided separately from the traffic information analysis device 30, and the FCD server may be configured to receive, from each vehicle 60, identification information, location information, time information, etc. of the vehicle 60. The traffic information analysis device 30 may thus be configured to acquire the identification, location information, and time information, etc. of each vehicle 60 from the FCD server.

Further, as another modified example, the FCD server may be configured to construct the visit information database 322 based on the identification information, location information, and time information, etc. received from each vehicle 60, and update the database, as necessary. In that case, the traffic information analysis device 30 may be configured to acquire information stored in the visit information database 322 from the FCD server, as necessary.

Further, as another modified example, although the display unit 34 and the input unit 35 are described as an input/output interface with a user in the above embodiments, the interface is not so limited. The input/output interface with the user may be realized via a user terminal (not shown) connected to the communication network 50 and being communicable with the traffic information analysis device 30.

Specifically, a configuration is possible in which, for example, a user logs into the traffic information analysis device 30 from the user terminal, then, after the traffic information analysis device 30 has determined that the user ID is valid, the traffic information analysis device 30 (analysis condition receiving unit 312) generates a user interface for receiving an input of analysis conditions from the user, and provides the generated interface to the user terminal, whereby the user may transmit the analysis conditions to the traffic information analysis device 30 via the user terminal 40.

In addition, the traffic information analysis device 30 (output unit 314) may be configured to output the number and/or ratio for each number of passages tallied by the number-of-passages tallying unit 313 to the user terminal. In response to this, the user terminal may display, for example, the display shown in FIG. 7A and FIG. 7B.

The user terminal may be realized by incorporating software for realizing the input/output interface function with the traffic information analysis device 30 into, for example, a personal computer or the like.

### <Regarding Hardware and Software>

It should be noted that each device included in the above navigation system can be realized by hardware, software, or a combination thereof. In addition, the navigation method performed by a cooperation of the devices included in the above navigation system can also be realized by hardware, software, or a combination thereof. Here, being realized by software means being realized by a computer reading and executing a program.

The program may be stored using various types of non-transitory computer-readable media, and may be provided to a computer. Non-transitory computer-readable media include various types of tangible storage media. Examples of non-transitory computer-readable media include magnetic storage media (e.g., flexible discs, magnetic tapes, hard disk drives), magneto-optical storage media (e.g., magneto-optical discs), CD-ROM (Read Only Memory), CD-R, CD-R/W, and semiconductor memories (e.g., mask ROM, PROM (programmable ROM), EPROM (erasable PROM), flash ROM, and RAM (random access memory)). The program may also be provided to a computer by means of various types of transitory computer-readable media. Examples of transitory computer-readable media include electrical signals, optical signals, and electromagnetic waves. Transitory computer-readable media may provide the program to a computer through wired communication paths such as electrical wires or optical fibers, or through wireless communication paths.

### EXPLANATION OF REFERENCE NUMERALS

1 Traffic information analysis system

10 Onboard navigation device

11, 21, 31 Control unit

111, 211 Route guiding unit

112, 212 Location information transmission unit

12, 22, 32 Storage unit

121, 221 Location information

122, 222 Mobile body Identification information

13, 23, 33 Communication unit

14, 24 Sensor unit

15, 25, 34 Display unit

16, 26, 35 Input unit

20 Portable terminal

27 Short range communication unit

30 Traffic information analysis device

311 Visit information database updating unit

312 Analysis condition receiving unit

313 Number-of-passages tallying unit

314 Output unit

315 Home location identifying unit

321 Map information

322 Visit information database

50 Communication network

60, 60a, 60b Vehicle

1. A traffic information analysis device comprising.
a receiving unit configured to receive changes in location information for a plurality of mobile bodies;
a map information storage unit configured to store a road on which the plurality of mobile bodies can travel;
a number-of-passages tallying unit configured to tally a number of passages of each of the plurality of mobile bodies within a predetermined period fora predetermined location or predetermined section of the road; and
an output unit configured to output a number and/or ratio of mobile bodies having passed through the predetermined section or predetermined location of the road within the predetermined period for each number of passages

2. The traffic information analysis device according to claim 1, wherein the number-of-passages tallying unit further tallies a number of passages for the plurality of mobile bodies respectively for weekdays and for holidays.

3. The traffic information analysis device according to claim 1, further comprising:
a home location identifying unit configured to register in advance or identify by a tally of departure locations and/or arrival locations a home location for each of the plurality of mobile bodies, and
the number-of-passages tallying unit further tallies a number of passages for mobile bodies having a home location that is beyond a predetermined distance from the predetermined section or predetermined location.

4. The traffic information analysis device according to claim 1, wherein the map information storage unit further stores a location of a facility, and
the number-of-passages tallying unit further has as a tallying target a predetermined section of a road identified by a movement route of a vehicle that has passed the location of the facility that has been designated.

5. A traffic information analysis method performed by one or more computers having a map information storage unit storing a road on which a plurality of mobile bodies can travel, the method comprising:
a receiving step of receiving changes in location information for the plurality of mobile bodies;
a number-of-passages tallying step of tallying a number of passages of each of the plurality of mobile bodies within a predetermined period for a predetermined location or a predetermined section of the road; and
an output step of outputting a number and/or ratio of mobile bodies having passed through the predetermined section or predetermined location of the road within the predetermined period for each number of passages.
